(19) United States
(12) Patent Application Publication
(10) Pub. No.: US 2026/0221751 A1
(43) Pub. Date: Jul. 30, 2026

(54) SEMICONDUCTOR DEVICE

(71) Applicant: Renesas Electronics Corporation, Tokyo (JP)

(72) Inventor: Makoto TANAKA, Tokyo (JP)

(21) Appl. No.: 19/064,484

(22) Filed: Feb. 26, 2025

(30) Foreign Application Priority Data
Jan. 29, 2025 (JP) 2025-013263

(51) Int. Cl. H02H 3/08; H02H 1/00

(52) U.S. Cl. CPC H02H 3/08; H02H 1/0007

(57) ABSTRACT

The semiconductor device comprises a first and a second comparator configured to compare an input voltage corresponding to a sense current detected by an output current of a power transistor with a first reference voltage and a second reference voltage respectively, the second reference voltage being lower than the first reference voltage. The semiconductor device further comprises a first and second counter respectively coupled to the first and second comparator and configured to count up and down, an adder circuit coupled to the first counter and the second counter and configured to calculate a total value of count values of the first counter and the second counter, and a detection signal output circuit configured to output a detection signal when the total value of the count values is equal to or greater than a threshold value.

### CROSS-REFERENCE TO RELATED APPLICATIONS

The disclosure of Japanese Patent Application No. 2025-013263 filed on Jan. 29, 2025, including the specification, drawings and abstract is incorporated herein by reference in its entirety.

### BACKGROUND

Present disclosure relates to a semiconductor device. Power semiconductor devices are used to drive loads such as motors, heaters and lamps in vehicles. Power MOSFET and IGBT (Insulated Gate Bipolar Transistor) are used as the power devices. Further, in order to reduce the size and cost of products, IPD (Intelligent Power Device in which a power MOSFET chip and a control chip (including protection circuit) are mounted in one package has also been used. In these semiconductor devices, countermeasures to protect against overheating using thermal sensors such as diodes have become essential.

Power from a DC power supply drives loads (e.g., lights, motors, ECU (Electronic Control Unit) via IPD. Heretofore, a mechanical fuse has been installed between the DC power supply and IPD as a measure to protect a harness from smoke-producing. However, the mechanical fuse is severely deteriorated, and the capacity for current decreases during use. Therefore, it is necessary to increase the ampere of the fuse in order to secure a certain amount of current capacity even when deteriorated, it is necessary to have a thick wiring that can tolerate the increased ampere. In addition, the mechanical fuse is periodically blown out and needs to be replaced. Therefore, the mechanical fuse needs to be placed in a replaceable accessible position.

There are disclosed techniques listed below.
[Patent Document 1] Japanese Unexamined Patent Application Publication No. 2022-192015
[Patent Document 2] Japanese Unexamined Patent Application Publication No. 2023-152696

### SUMMARY

In view of this background, electronization measures have been taken to incorporate the functions of mechanical fuses into IPD. One such electronic fuse technique is I2t protection. In the I2t protection, an integrated value of the current flowing through the fuse is calculated, and the harness is protected based on the calculated value. This eliminates the need for thick wires, and also eliminates the need for mechanical fuse replacement, thereby reducing the weight of device and improving the flexibility of the arrangement. It is also programmable and capable of supporting software demand vehicles. There is now a need for I2t protection that provides more accurate harness protection with simpler implementations. Other objects and novel features will become apparent from the description of this specification and the accompanying drawings.

A target fuse characteristic curve needs to be set between a curve of a maximum load current and a curve of a smoke-producing limit characteristics of a wire harness. FIG. 1 is a diagram illustrating a target fuse characteristics according to a present disclosure. The horizontal axis represents time, and the vertical axis represents current (A). FIG. 1 shows a graph of a current-time characteristics when a constant current continues to flow. An exemplary curve of the smoke-producing limit characteristics of a wire harness indicates that smoke is produced from the wire harness as a function of time (t1) when a constant current (I1) continues to flow. A curve of the maximum load current shows an example of the maximum value of the load current used by customers. The target fuse characteristics need to be set to a curve that satisfies the maximum value of the load current by customers and is below the smoke-producing limit characteristics of the wire harness.

The present inventor has considered a calculation equation for determining an approximate equation of the target fuse characteristics curve. First, the target fuse characteristics can be determined as follows.

$$SUM = \sum I \hat{} 2 \qquad ( Equation 1 )$$

However, since I\hat{ }2 is always positive, when I\hat{ }2 is integrated over a long period of time using Equation 1, it always reaches the threshold. The current value should saturate over time. Therefore, it is considered inappropriate to define the approximate expression of the target fuse characteristic curve as Equation 1.

Therefore, a heat dissipation element is added into the equation. The heat dissipation element is set to SUM(n−1)*B so as to depend on the integrated value (that is, as the integrated value increases, the degree of heat dissipation also increases). The approximate equation of the target fuse characteristic curve may be determined as follows:

$$SUM [ N ] = \sum A * I \hat{} 2 - B * SUM ( N - 1 ) \qquad ( Equation 2 )$$

As described above, there is a need to provide a semiconductor device having a function of a fuse, which is relatively simple and includes a calculation circuit for executing new computational methods while incorporating a heat dissipation element.

A semiconductor device according to an aspect of the present disclosure comprises a first comparator configured to compare an input voltage corresponding to a sense current detected by an output current of a power transistor with a first reference voltage, a second comparator configured to compare the input voltage corresponding to the sense current detected by the output current of the power transistor with a second reference voltage being lower than the first reference voltage, a first counter coupled to the first comparator and configured to count down, and, when the input voltage corresponding to the sense current becomes equal to or greater than the first reference voltage, count up, a second counter coupled to the second comparator and configured to count down, and when the input voltage corresponding to the sense current becomes equal to or greater than the second reference voltage, count up, an adder circuit coupled to the first counter and the second counter, and configured to calculate a total value of count values of the first counter and the second counter, and a detection signal output circuit configured to output a detection signal when the total value of the count values is equal to or greater than a threshold value.

A semiconductor device according to an aspect of the present disclosure comprises a first comparator configured to compare an input voltage corresponding to a sense current detected by an output current of a power transistor with a first reference voltage, a second comparator configured to compare the input voltage corresponding to the sense current detected by the output current of the power transistor with a second reference voltage being lower than the first reference voltage, a first counter coupled to the first comparator and configured to count up, and when the input voltage corresponding to the sense current becomes equal to or greater than the first reference voltage, count down, a second counter coupled to the second comparator and configured to count up, and when the input voltage corresponding to the sense current becomes equal to or greater than the second reference voltage, count down, an adder circuit coupled to the first counter and the second counter, and configured to calculate a total value of count values of the first counter and the second counter, and a detection signal output circuit configured to output a detection signal when the total value of the count values is equal to or smaller than a threshold value.

According to the present disclosure, it is possible to provide a semiconductor device having a function of a fuse, which is relatively simple and has a calculation circuit for executing a new calculation method while incorporating a heat dissipation element.

### BRIEF DESCRIPTION OF THE DRAWINGS

FIG. 1 is the target fuse characteristics according to the present disclosure.

FIG. 2 is a diagram for explaining an entire configuration of a semiconductor device according to an embodiment.

FIG. 3 is a diagram for explaining a calculation circuit according to the embodiment.

FIG. 4 is a diagram for explaining the target fuse characteristics according to the first embodiment.

FIG. 5 is a diagram for explaining a state of counters when the constant current applied according to the first embodiment.

FIG. 6 is a diagram for explaining a calculation circuit according to a second embodiment.

FIG. 7 is a diagram for illustrating an exemplary curve showing the target fuse characteristics according to the second embodiment.

### DETAILED DESCRIPTION

Embodiments of the present disclosure will be described below referring to the drawings. In the specification and the drawings, the same or corresponding form elements are denoted by the same reference numerals, and a repetitive description thereof is omitted. In the drawings, for convenience of description, the configuration may be omitted or simplified. Also, at least some of the embodiments may be arbitrarily combined with each other.

### First Embodiment

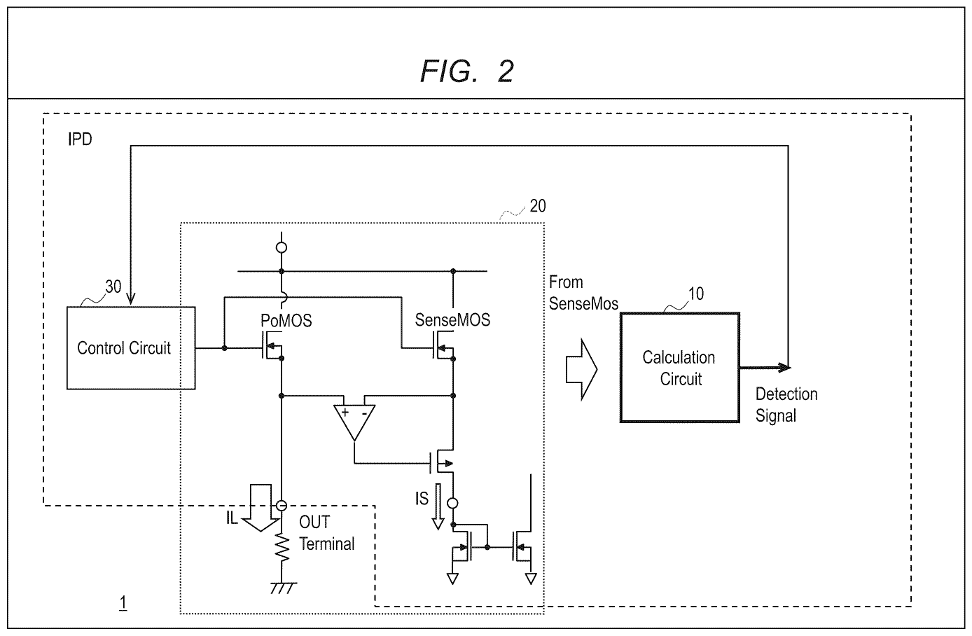

FIG. 2 is a diagram for explaining an entire configuration of a semiconductor device according to the embodiment.

A semiconductor device 1 includes a calculation circuit 10, a current detection circuit 20, and a control circuit 30. The semiconductor device 1 is also referred to as IPD (Intelligent Power Device). The calculation circuit 10 comprises a FUSE function circuit and is also referred to as an I2t (Ampere-square second). Note that in some embodiments, ADC (Analog to Digital Converter) may be included after the current detection circuit 20.

The calculation circuit 10 reads a current from the current detection circuit 20. The calculation circuit 10 may read a digital current from the current detection circuit 20 via an ADC. The calculation circuit 10 transmits a control signal to the control circuit 30 according to the calculation result. The control circuit 30 receives the control signal from the calculation circuit 10 and controls a field-effect transistor (hereinafter, also referred to as “PoMOS” or a power transistor) for power of the current detection circuit 20. The current detection circuit 20 includes a PoMOS and a SenseMOS. The SenseMOS is a MOS having the same structure as PoMOS, and significantly smaller than PoMOS. For example, PoMOS:SenseMOS may be 10000:1, 100000:1. For example, at 10000:1, a current of 1/10000 of PoMOS flows through SenseMOS.

The current detection circuit 10 performs a calculation according to the present disclosure based on the digital current obtained by reading an analog current from the current detection circuit 20(SenseMOS) via the ADC. When the calculation result exceeds a threshold value, the calculation circuit 10 transmits the control signal to the control circuit 30. The control circuit 30 stops PoMOS in the current detection circuit 20 based on the control signal. Thus, the function of the electronic fuse can be realized.

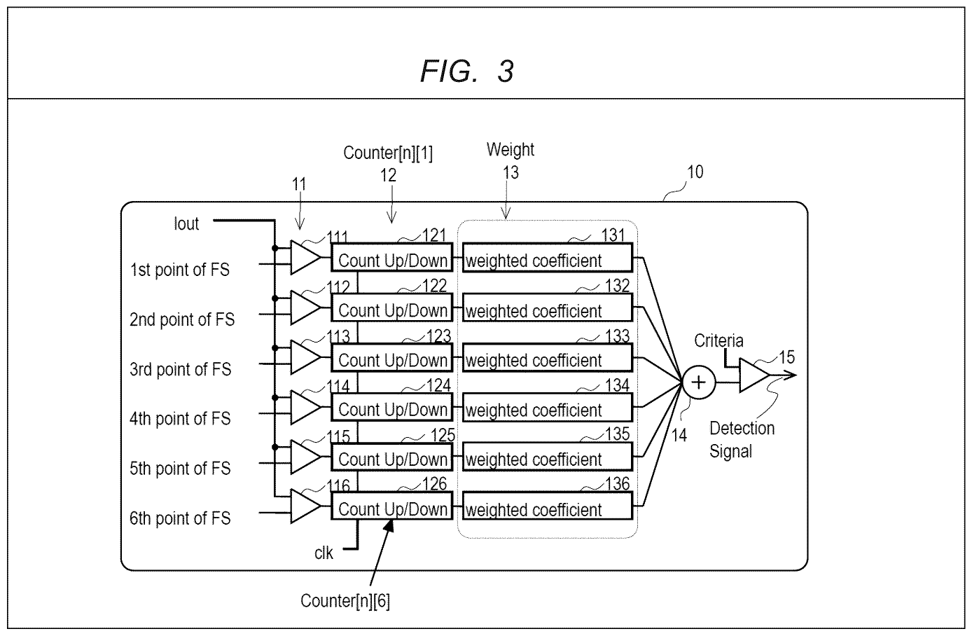

FIG. 3 is a diagram for explaining the calculation circuit according to the embodiment.

The calculation circuit 10 improves the above-described Equation 2 and embodies the following Equation 3.

$$S = {\sum }_{x = 1}^{n} [ {CNT}_{x}^{′} + [ ( if ( {I}_{L} > {FP}_{x} ) = 1 , else 0 ) \times {WC}_{x} - {CNT}_{x}^{′} ] \times \frac{Δ t}{{τ}_{x}} ] \qquad ( Equation 3 )$$

CNT: Count Function
FP: Threshold
WC: Weighted coefficient
Δt: Count step
τ: Weight

In Equation 3, the following term corresponds to heat generation.

$$( if ( {I}_{L} > {FP}_{x} ) = 1 , else 0 ) \times {WC}_{x}$$

In other words, each counter is configured to count up corresponding to heat generation when an input voltage corresponding to the sense current becomes equal to or greater than a first reference voltage.

In Equation 3, the following term corresponds to heat dissipation.

$$- {CNT}_{x}^{′}$$

That is, each counter is configured to count down corresponding to heat dissipation.

As illustrated in FIG. 3, the calculation circuit 10 includes a plurality of counters 12, and adds a value obtained by multiplying a count value from the each counter 12 by each weight 13. Each counter 12 performs counting-up and counting-down. The counting-up corresponds to heat generation and the counting-down corresponds to heat dissipation. The counting-up starts when the current exceeds a threshold current set in the counter. That is, each counter counts down, and when the input voltage corresponding to the sense current becomes equal to or greater than a reference voltage of each counter, counts up. Each counter 12 is coupled to a same clock. Each counter is provided for every t (time) of t (time)-I (current), and the presence/absence of counting-up and the amount of counting-up correspond to I (current). FIG. 3 shows the case where n=6, i.e. six comparators 11 (111~116) and six counters 12 (121~126).

A first comparator 111 receives a voltage corresponding to the sense current Iout and a first reference voltage (1st point of FS) from the two input terminals, compares the potential difference between the input terminals, and outputs a comparison result. Similarly, a second comparator 112 receives a voltage corresponding to the sense current Iout and a second reference voltage (2nd point of FS) to the two input terminals, compares the potential difference between the input terminals, and outputs a comparison result. A third comparator 113 receives a voltage corresponding to the sense current Iout and a third reference voltage (3rd point of FS) to the two input terminals, compares the potential difference between the input terminals, and outputs a comparison result. A fourth comparator 114 receives a voltage corresponding to the sense current Iout and a fourth reference voltage (4th point of FS) to the two input terminals, compares the potential difference between the input terminals, and outputs a comparison result. A fifth comparator 115 receives a voltage corresponding to the sense current Iout and a fifth reference voltage (5th point of FS) to the two input terminals, compares the potential difference between the input terminals, and outputs a comparison result. A sixth comparator 116 receives a voltage corresponding to the sense current Iout and a sixth reference voltage (6th point of FS) to the two input terminals, compares the potential difference between the input terminals, and outputs a comparison result.

The first reference voltage of the first comparator 111 is reduced in a stepwise fashion by the first reference voltage, second reference voltage, third reference voltage, fourth reference voltage, fifth reference voltage, and sixth reference voltage.

A first counter 121 is coupled to an output terminal of the first comparator 111. A second counter 122 is coupled to an output terminal of the second comparator 112. A third counter 123 is coupled to an output terminal of the third comparator 113. A first counter 124 is coupled to an output terminal of the fourth comparator 114. A fifth counter 125 is coupled to an output terminal of the fifth comparator 115. A sixth counter 126 is coupled to an output terminal of the sixth comparator 116.

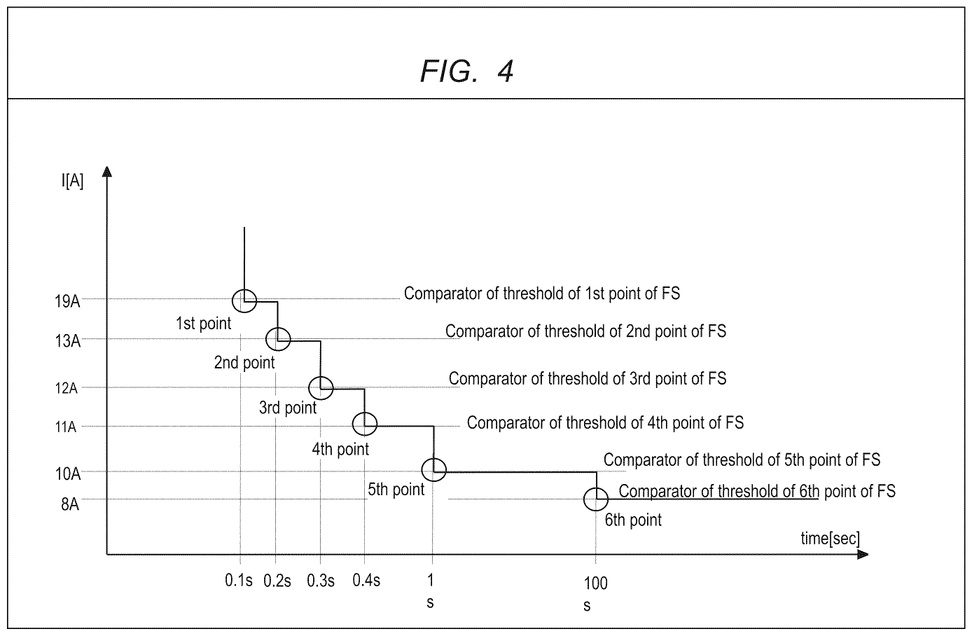

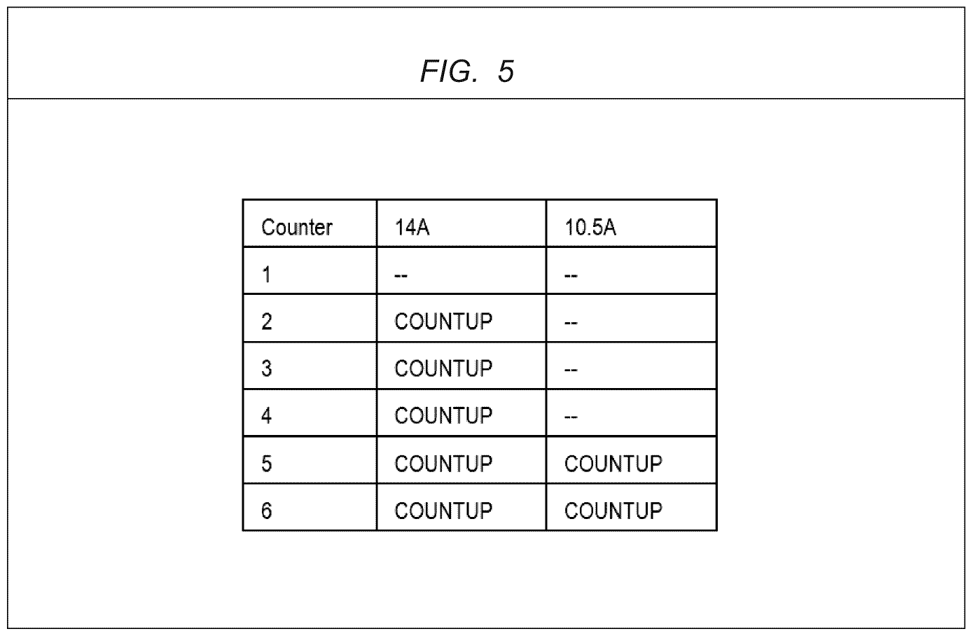

Each counter 12 performs counting-up and counting-down according to the comparison result of each comparator 11. The counting-down is performed only when the input-voltage corresponding to the sense current becomes less than or equal to reference voltage. When the voltage corresponding to the sense current exceeds reference voltage, both counting-up and counting-down are performed. The larger the output current from the power transistor, the greater the number of counters performing counting-up. Details of the counting-up will be described later with reference to FIGS. 4 and 5.

A first weight 131 is coupled to an output terminal of the first counter 121. A second weight 132 is coupled to an output terminal of the second counter 122. A third weight 133 is coupled to an output terminal of the third counter 123. A fourth weight 134 is coupled to an output terminal of the fourth counter 124. A fifth weight 135 is coupled to an output terminal of the fifth counter 125. A sixth weight 136 is coupled to an output terminal of the sixth counter 126. By adjusting the weight amount of each counter, it is possible to adjust each detection time interval.

The first weight 131, the second weight 132, the third weight 133, the fourth weight 134, the fifth weight 135, and the sixth weight 136 are respectively coupled to an adder circuit 14. The adder circuit 14 calculates a total value of the count values of the respective counters 12 (or the counter values obtained by weighting the respective weights thereto).

An output terminal of the adder circuit 14 is coupled to a detection signal output circuit 15. The detection signal output circuit 15 is a comparator, and compares reference voltage with the output (total value) from the adder circuit 14, and outputs a comparison result. The detection signal output circuit 15 transmits a detection signal to the control circuit 30 when the output (total value) from the adder circuit 14 exceeds reference voltage (that is, when the output exceeds the target fuse characteristics).

As shown in FIG. 2, upon receiving the detection signal from the calculation circuit 10, the control circuit 30 transmits a current interruption signal to PoMOS of the current detection circuit 20. The control circuit 30 may also be referred to as a current cutoff circuit, a PoMOS driver circuit, a pre-driver, a PoMOS control circuit, or the like.

FIG. 4 is a diagram for illustrating an example of the target fuse characteristics. FIG. 5 is a diagram for explaining the state of each counter in the case of a constant current.

Each threshold current of the comparator 11 of the calculation circuit 10 shown in FIG. 3 corresponds to a current at a point where a curve indicating the target fuse characteristics of FIG. 4 changes. As shown in FIG. 4, the threshold current of the first comparator 111 is highest, and the threshold currents of the second comparator 112 to the sixth comparator 116 are lower in order. The number of comparators and counters is not limited to this. The calculation circuit 10 according to the present disclosure may include n comparators 11 and n counters 12 (n is an integer equal to or greater than 3). Each comparator 11 has a different threshold current, and each threshold current is set to be stepwise lower. The counting-up means that the current has exceeded the threshold current set in each counter (i.e., each comparator).

As shown in FIG. 5, when the current is 14 A, the second to sixth counters 122 to 126 count up since the current value is equal to or less than the threshold current of the first comparator 111 of the first counter 121 and is equal to or greater than the threshold current of the comparators 112 to 126 of the second to sixth counters 122 to 126. When the current 10.5 A, the fifth and sixth counters 125,126 count up since the current value is equal to or less than the threshold current of the fourth comparator from the first comparator 111 to the fourth counter 124 of the first counter 121 and is equal to or greater than the threshold current of the comparators 115 and 126 of the fifth and sixth counters 125 and 126. That is, as the output current from the power transistor increases, the number of counters for performing counting up increases.

In the calculation circuit of FIG. 3, as the amount of current increases, many counters count up, and therefore the detection threshold value is reached earlier than when the amount of current decreases. As a result, the current can be interrupted quickly. In addition, the detection time for interrupting the current varies stepwise according to the threshold current that is set stepwise. Therefore, it is possible to create a stepped detection line (target fuse characteristics) in accordance with time.

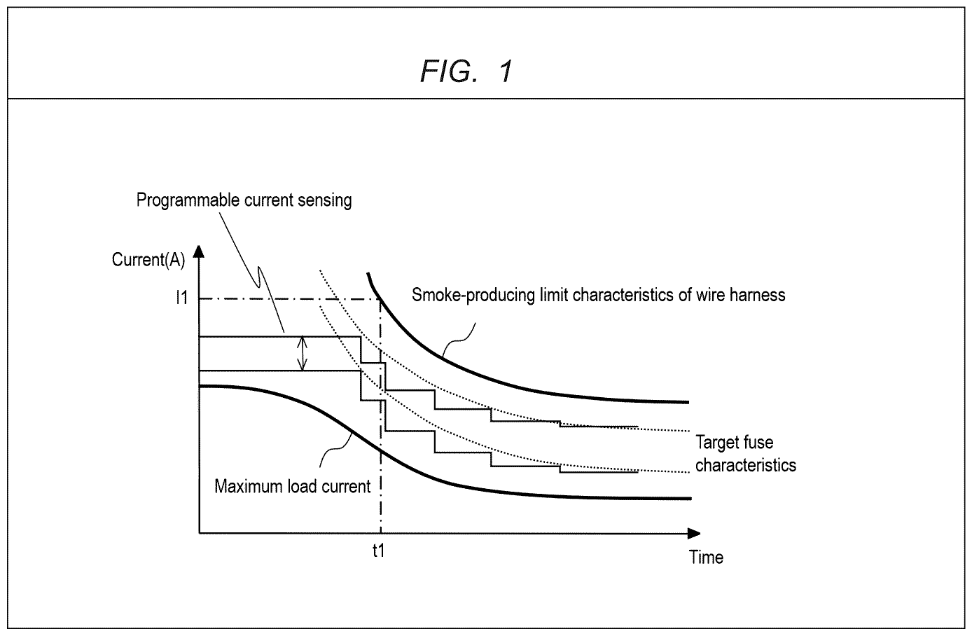

Further, by adjusting the weight amount of each counter, it is possible to adjust the respective detection time intervals. For example, in the case of FIG. 4, the thresholds are set at 0.1 s intervals, but the detection interval can be shortened by increasing the weight of a certain counter. Users can adjust the weight to arbitrarily adjust which curve the target fuse characteristic curve approaches between the smoke-producing limit characteristics curve and the maximum load current curve shown in FIG. 1. The programmable current sensing according to the present disclosure can be varied by OTA (Over the Air) to flexibly maintain safety. Thus, even when the load to be used increases, the target fuse characteristics can be changed. The emulation time may be determined by the sum of the power consumption considering the target fuse characteristics.

According to the first embodiment described above, it is possible to provide the semiconductor device having the function of the fuse, which is relatively simple and includes the calculation circuit for executing the new calculation process while incorporating a heat dissipation element. Further, such a calculation circuit is relatively easy to mount on an integrated circuit, and the degree of freedom in arrangement is improved as compared with a mechanical fuse. It is also possible to support software demand vehicles.

### Second Embodiment

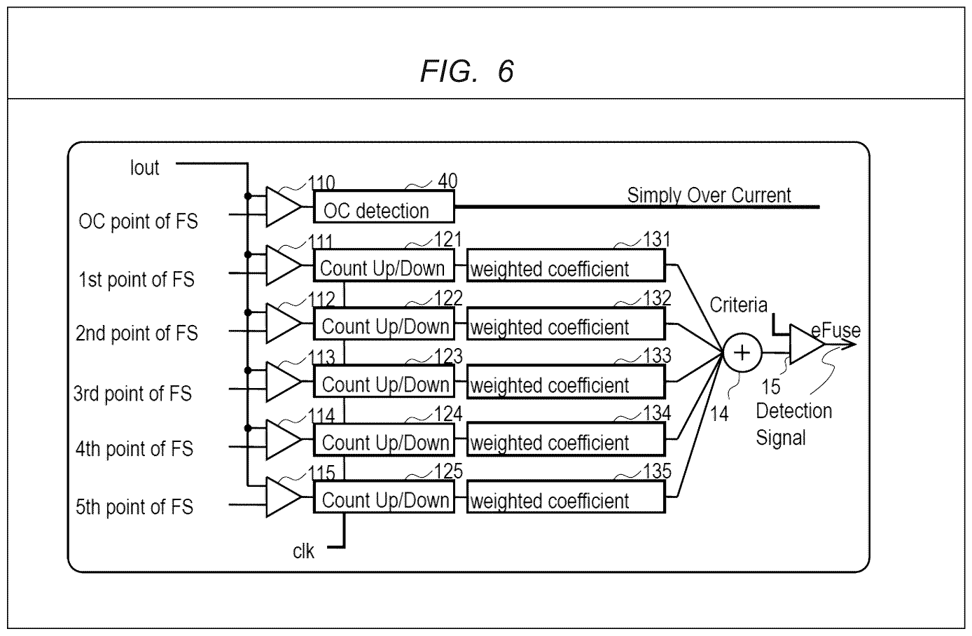

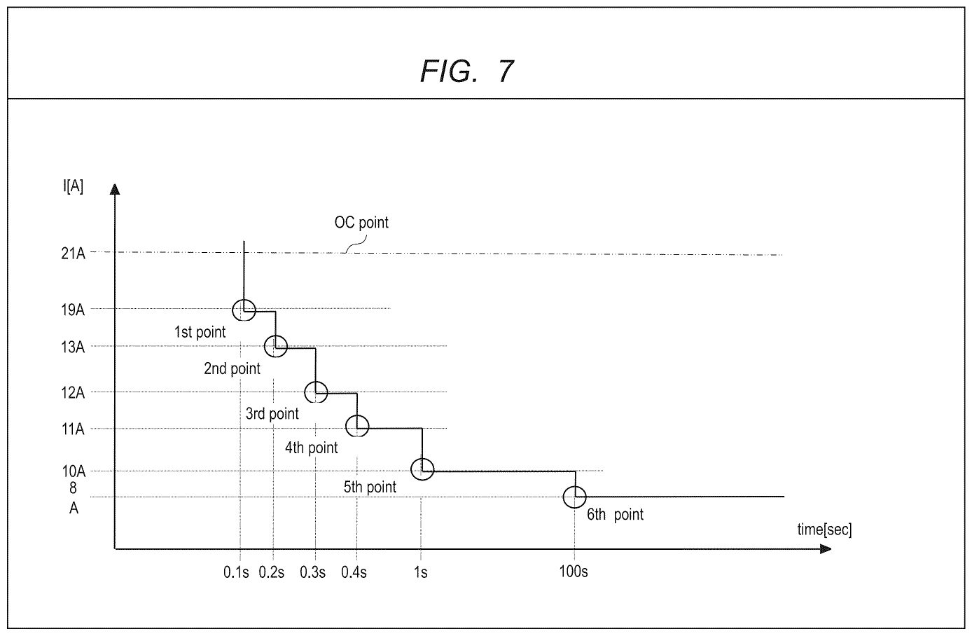

FIG. 6 is a diagram for explaining the calculation circuit according to the second embodiment. FIG. 7 is a diagram for illustrating exemplary a curve showing the target fuse characteristics according to the second embodiment. Unlike the calculation circuit according to the first embodiment shown in FIG. 1, an overcurrent detection circuit 40 coupled to the comparator 110 is added. The threshold current of the comparator 110 is set to be higher than the threshold current of the highest first comparator 111 (for example, 21 A), as indicated by the two-dot broken line in FIG. 7. That is, when the overcurrent detection circuit 40 detects a current higher than the threshold current of the comparator 110, the overcurrent detection circuit 40 transmits a detection signal to the control circuit 30. The control circuit 30 may receive the sense signal and instantaneously disconnect the current of the power transistor. In this case, the control circuit 30 may also be referred to as an overcurrent protection circuit or an overcurrent stop circuit.

According to the second embodiment, it is possible to provide the semiconductor device having a highly safe fuse function by detecting an overcurrent in addition to a current interruption due to the target fuse characteristics.

The semiconductor device according to some embodiments, the semiconductor device comprises a first comparator configured to compare an input voltage corresponding to a sense current detected by an output current of a power transistor with a first reference voltage, a second comparator configured to compare the input voltage corresponding to the sense current detected by the output current of the power transistor with a second reference voltage being lower than the first reference voltage, a first counter coupled to the first comparator and configured to count up, and when the input voltage corresponding to the sense current becomes equal to or greater than the first reference voltage, count down, a second counter coupled to the second comparator and configured to count up, and when the input voltage corresponding to the sense current becomes equal to or greater than the second reference voltage, count down, an adder circuit coupled to the first counter and the second counter, and configured to calculate a total value of count values of the first counter and the second counter, and a detection signal output circuit configured to output a detection signal when the total value of the count values is equal to or less than a threshold value.

In another embodiment, the semiconductor device may include an overcurrent detection comparator configured to input the input voltage corresponding to the sense current detected by the output current of the power transistor with a reference voltage for overcurrent detection being greater than the first reference voltage, and output a comparison result, and an overcurrent protection circuit coupled to the overcurrent detection comparator, and configured to output a signal for stopping the overcurrent to the power transistor based on the comparison result.

In another embodiment, in the semiconductor device, the total value calculated by the adder circuit is based on an integrated value of the output current of the power transistor.

In another embodiment, in the semiconductor device, a first weight for changing a weight of the count value of the first counter is coupled between the first counter and the adder circuit, and a second weight for changing a weight of the count value of the second counter is coupled between the second counter and the adder circuit.

In another embodiment, the semiconductor device may comprise a plurality of comparators comprising the first comparator, the second comparator, and a n-th comparator (n is an integer equal to or greater than 3), a plurality of counters comprising the first counter, the second counter, and a n-th comparator, and a plurality of weights comprising the first weight, the second weight, and a n-th weight, and wherein reference voltages of the first comparator, the second comparator, and the n-th comparator are set to decrease stepwise in order.

In another embodiment, the semiconductor device may further comprise a control circuit configured to receive the detection signal and interrupt a current of the power transistor.

Unlike the above described embodiment, it may be counted down when the voltage corresponding to the sense current becomes equal to or greater than reference voltage, and may be counted up when the voltage is equal to or smaller than reference voltage. That is, in some embodiments, the positive and negative count values may be controlled with opposite values. In this case, the heat dissipation may correspond to counting-up and the heat generation may correspond to counting-down.

In other words, in another embodiment, a semiconductor devise may be provided that comprises a first comparator configured to compare an input voltage corresponding to a sense current detected by an output current of a power transistor with a first reference voltage, a second comparator configured to compare the input voltage corresponding to the sense current detected by the output current of the power transistor with a second reference voltage being lower than the first reference voltage, a first counter coupled to the first comparator and configured to count up, and when the input voltage corresponding to the sense current becomes equal to or greater than the first reference voltage, count down, a second counter coupled to the second comparator and configured to count up, and when the input voltage corresponding to the sense current becomes equal to or greater than the second reference voltage, count down, an adder circuit coupled to the first counter and the second counter, and configured to calculate a total value of count values of the first counter and the second counter, and a detection signal output circuit configured to output a detection signal when the total value of the count values is equal to or smaller than a threshold value.

In another embodiment, the semiconductor device may comprise an overcurrent detection comparator configured to input the input voltage corresponding to the sense current detected by the output current of the power transistor with a reference voltage for overcurrent detection being greater than the first reference voltage, and output a comparison result, and an overcurrent protection circuit coupled to the overcurrent detection comparator, and configured to output a signal for stopping the overcurrent to the power transistor based on the comparison result.

In the semiconductor device according to another embodiment, the total value calculated by the adder circuit is based on an integrated value of the output current of the power transistor.

In the semiconductor device according to another embodiment, a first weight for changing a weight of the count value of the first counter is coupled between the first counter and the adder circuit, and a second weight for changing a weight of the count value of the second counter is coupled between the second counter and the adder circuit.

In the semiconductor device according to another embodiment, the semiconductor device may comprise a plurality of comparators comprising the first comparator, the second comparator, and a n-th comparator (n is an integer equal to or greater than 3), a plurality of counters comprising the first counter, the second counter, and a n-th comparator, and a plurality of weights comprising the first weight, the second weight, and a n-th weight, and wherein reference voltages of the first comparator, the second comparator, and the n-th comparator are set to decrease stepwise in order. In the semiconductor device according to another embodiment, the semiconductor device may further comprise a control circuit configured to receive the detection signal and interrupt a current of the power transistor.

Although the invention made by the present inventor has been specifically described based on the embodiment, the present invention is not limited to the embodiment described above, and it is needless to say that various modifications can be made without departing from the gist thereof. The plurality of examples described above may be implemented in combination as appropriate.

What is claimed is:

1. A semiconductor device comprising:
a first comparator configured to compare an input voltage corresponding to a sense current detected by an output current of a power transistor with a first reference voltage
a second comparator configured to compare the input voltage corresponding to the sense current detected by the output current of the power transistor with a second reference voltage being lower than the first reference voltage,
a first counter coupled to the first comparator and configured to count down, and, when the input voltage corresponding to the sense current becomes equal to or greater than the first reference voltage, count up,
a second counter coupled to the second comparator and configured to count down, and when the input voltage corresponding to the sense current becomes equal to or greater than the second reference voltage, count up,
an adder circuit coupled to the first counter and the second counter, and configured to calculate a total value of count values of the first counter and the second counter, and
a detection signal output circuit configured to output a detection signal when the total value of the count values is equal to or greater than a threshold value.

2. The semiconductor device according to claim 1, further comprising:
an overcurrent detection comparator configured to
input the input voltage corresponding to the sense current detected by the output current of the power transistor with a reference voltage for overcurrent detection being greater than the first reference voltage, and
output a comparison result,
an overcurrent protection circuit coupled to the overcurrent detection comparator, and configured to output a signal for stopping the overcurrent to the power transistor based on the comparison result.

3. The semiconductor device according to claim 1, wherein the total value calculated by the adder circuit is based on an integrated value of the output current of the power transistor.

4. The semiconductor device according to claim 1, wherein a first weight for changing a weight of the count value of the first counter is coupled between the first counter and the adder circuit, and a second weight for changing a weight of the count value of the second counter is coupled between the second counter and the adder circuit.

5. The semiconductor device according to claim 4, further comprising:
a plurality of comparators comprising the first comparator, the second comparator, and a n-th comparator (n is an integer equal to or greater than 3),
a plurality of counters comprising the first counter, the second counter, and a n-th comparator, and
a plurality of weights comprising the first weight, the second weight, and a n-th weight, and
wherein reference voltages of the first comparator, the second comparator, and the n-th comparator are set to decrease stepwise in order.

6. The semiconductor device according to claim 1, further comprising a control circuit configured to receive the detection signal and interrupt a current of the power transistor.

7. A semiconductor device comprising:
a first comparator configured to compare an input voltage corresponding to a sense current detected by an output current of a power transistor with a first reference voltage,
a second comparator configured to compare the input voltage corresponding to the sense current detected by the output current of the power transistor with a second reference voltage being lower than the first reference voltage,
a first counter coupled to the first comparator and configured to count up, and when the input voltage corresponding to the sense current becomes equal to or greater than the first reference voltage, count down,
a second counter coupled to the second comparator and configured to count up, and when the input voltage corresponding to the sense current becomes equal to or greater than the second reference voltage, count down,
an adder circuit coupled to the first counter and the second counter, and configured to calculate a total value of count values of the first counter and the second counter, and
a detection signal output circuit configured to output a detection signal when the total value of the count values is equal to or smaller than a threshold value.

8. The semiconductor device according to claim 7, further comprising:
an overcurrent detection comparator configured to
input the input voltage corresponding to the sense current detected by the output current of the power transistor with a reference voltage for overcurrent detection being greater than the first reference voltage, and
output a comparison result,
an overcurrent protection circuit coupled to the overcurrent detection comparator, and configured to output a signal for stopping the overcurrent to the power transistor based on the comparison result.

9. The semiconductor device according to claim 7, wherein the total value calculated by the adder circuit is based on an integrated value of the output current of the power transistor.

10. The semiconductor device according to claim 7, wherein a first weight for changing a weight of the count value of the first counter is coupled between the first counter and the adder circuit, and a second weight for changing a weight of the count value of the second counter is coupled between the second counter and the adder circuit.

11. The semiconductor device according to claim 10, further comprising:
a plurality of comparators comprising the first comparator, the second comparator, and a n-th comparator (n is an integer equal to or greater than 3),
a plurality of counters comprising the first counter, the second counter, and a n-th comparator, and
a plurality of weights comprising the first weight, the second weight, and a n-th weight, and
wherein reference voltages of the first comparator, the second comparator, and the n-th comparator are set to decrease stepwise in order.

12. The semiconductor device according to claim 11, further comprising a control circuit configured to receive the detection signal and interrupt a current of the power transistor.
